(19) United States
(12) Patent Application Publication
(10) Pub. No.: US 2024/0294163 A1
(43) Pub. Date: Sep. 5, 2024

(54) CONTROLLING ELECTRONICALLY CONTROLLED TORQUE ACTUATORS FOR INTEGRATED VEHICLE MOTION CONTROL

(71) Applicant: GM Global Technology Operations LLC, Detroit, MI (US)

(72) Inventors: Saurabh Kapoor, Windsor (CA); Hassan Askari, Thornhill (CA); Mustafa Hakan Turhan, Kitcherner (CA); SeyedAlireza Kasaiezadeh Mahabadi, Novi, MI (US); Jason D. Fahland, Fenton, MI (US)

(21) Appl. No.: 18/177,344

(22) Filed: Mar. 2, 2023

(51) Int. Cl. B60W 20/15; B60W 10/06; B60W 10/08; B60W 10/14

(52) U.S. Cl. CPC B60W 20/15; B60W 10/06; B60W 10/08; B60W 10/14; B60W 2720/26; B60W 2720/40

(57) ABSTRACT

A system to map control system configurations for vehicle torque actuators includes a control unit of a vehicle. A first torque actuator of a first power unit delivers torque to rear wheels of the vehicle, and a second torque actuator of a second power unit delivers torque to front wheels of the vehicle. Multiple input items are received by the control unit, including: multiple configurations; one or more operating points; multiple configuration classifications including: a torque constraint; a torque reference; and an enabling condition; and identification of one or more priority assignments. The priority assignments are applied to the configurations, the operating points and the configuration classifications to determine a control action as sensed vehicle operating conditions change. Individual ones of the configurations are mapped to a normalized torque split ratio.

### INTRODUCTION

The present disclosure relates to systems and methods to control torque actuators for vehicles.

Present vehicle longitudinal torque actuators for engines and electric motors must adhere to configurations of several systems such as propulsion, chassis control and advanced driver assistance systems (ADAS). It is important that control architecture for torque actuators meet a variety of configurations. Two design challenges occurring during a control architecture design are presently not being fully exploited. The control architecture should maintain a correct balance of integration and modularity in control to allow for effective control while maintaining future compatibility and ease-of-use/calibration.

In addition, a systematic method to resolve conflicting configurations is not currently available such that it may traverse several systems.

Thus, while current systems and methods to control torque actuators achieve their intended purpose, there is a need for a new and improved system and method to control torque actuators.

### SUMMARY

According to several aspects, a system to map control system configurations for vehicle torque actuators includes a control unit of a vehicle. A first torque actuator of a first power unit delivers torque to rear wheels of the vehicle, and a second torque actuator of a second power unit delivers torque to front wheels of the vehicle. Multiple input items are received by the control unit, including: multiple configurations; one or more operating points; multiple configuration classifications including: a torque constraint; a torque reference; and an enabling condition; and identification of one or more priority assignments. The priority assignments are applied to the configurations, the operating points and the configuration classifications to determine a control action as sensed vehicle operating conditions change. Individual ones of the configurations are mapped to a normalized torque split ratio.

In another aspect of the present disclosure, the configurations being categorized as reference points or constraints.

In another aspect of the present disclosure, the constraints further include a set of operating constraints including an understeering angle, a lateral acceleration, a velocity, a yaw rate, a desired drive torque and an estimated drive torque.

In another aspect of the present disclosure, a normalized measure of lateral stability is identified from the constraints; and an axle torque split ratio upper limit and an axle torque split ratio lower limit are also determined from the normalized measure of lateral stability.

In another aspect of the present disclosure, a priority-based arbitration as a function of the vehicle operating mode, the control unit accessing individual ones of the multiple configurations to establish a vehicle operating mode.

In another aspect of the present disclosure, the configurations are prioritized, including a first configuration deemed to be a highest priority and indicated as priority 1 and a second configuration deemed of a next highest priority and indicated as priority 2.

In another aspect of the present disclosure, the multiple configurations include at least one of: a desired torque; a traction value; propulsion limits; a slip target; a driver request; an eBoost signal from a second power unit; a steering neutrality; a total torque reduction; a traction control system (TCS) integration; and a rear traction limits overflow.

In another aspect of the present disclosure, the operating points include at least one of: a drive mode including tour or track; a traction control state including performance traction management (PTM) or electronic stability control (ESC); a surface friction (Mu); and a highway driving point.

In another aspect of the present disclosure, the first power unit defines a combustion engine; and the second power unit defines an electric motor.

In another aspect of the present disclosure, the multiple input items include identification of one or more operating points, including: a drive mode including tour or track; a traction control state including performance traction management (PTM) or electronic stability control (ESC); a surface friction (Mu); and a highway driving point.

According to several aspects, a method to map control system configurations for vehicle torque actuators, comprises: translating torque elements to allow differing torque items to be evaluated and modified using a common database; performing a configurations prioritization from a group of configurations to identify a priority assigned to individual ones of the torque elements; fusing the configurations prioritization according to the torque elements and the priority assigned together; determining multiple control actions; generating a target delta slip speed as measures of vehicle axle saturation; and regulating the target delta slip speed using a nonlinear proportional integral derivative (PID) regulator.

In another aspect of the present disclosure, the method further includes the translating torque elements includes in a mapping stage given sets of the group of configurations (Ri) and a set of operating points (o₁) defining multiple pairs (Ri, o₁) mapping to individual configurations of the group of configurations and individual ones of the operating points one of: an axle torque split ratio reference point of an axle torque split ratio; one or more axle torque split ratio constraints of the axle torque split ratio; and control system configurations such as a fuel economy.

In another aspect of the present disclosure, the method further includes: translating at least a first one of the multiple control actions as a lateral stability motion control into a torque bias ratio and assigning a maximum of a minimum constraint; and translating at least a second one of the multiple control actions as a wheel stability control into the torque bias ratio and assigning a reference point.

In another aspect of the present disclosure, the method further includes mapping to individual ones of the multiple pairs from (Ri, o₁) to (rₘ, oₙ) the following items, including: 1) enabling conditions; and 2) the priority.

In another aspect of the present disclosure, the method further includes: collecting all of the group of configurations Ri for the set of operating points (o₁) in a first collection step; collecting all of the group of configurations Ri for the set of operating points oₙ in a second collection step; inputting an output of the first collection step into a first chart, the first chart including an operating point 1 column and a priority block having priorities ranging from 1 through 5 for an operating point 1; identifying a configuration for individual ones of the priorities for the operating point 1 using the first chart; inputting an output of the second collection step into a second chart, the second chart including an operating point n column and a priority block having priorities ranging from 1 through 5 for the operating point n; and identifying a configuration for individual ones of the priorities for the operating point n using the second chart.

In another aspect of the present disclosure, the method further includes translating indicators of a vehicle lateral state to a normalized measure of lateral stability, which admits the constraints on the axle torque split ratio.

In another aspect of the present disclosure, the method further includes translating a control action for wheel stability control into a torque bias ratio and assigning as a reference point.

According to several aspects, a method to map control system configurations for vehicle torque actuators, comprises: delivering torque to rear wheels of a vehicle using a first torque actuator of a first power unit, and delivering torque to front wheels of the vehicle using a second torque actuator of a second power unit; translating elements of the torque into a domain to allow differing ones of the elements of the torque to be evaluated and modified using a common database; coordinating a feedback-based delta slip-speed regulation control and a lateral motion control; coordinating a hybrid boost control and an external traction control system; and performing non-linear gain scheduling of a controller to regulate dynamics of a wheel slip.

In another aspect of the present disclosure, the method further includes performing a configurations prioritization using a group of configurations to identify a priority to be assigned to individual ones of the elements of the torque.

In another aspect of the present disclosure, the method further includes mapping individual ones of the group of configurations to a normalized torque split ratio.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic presentation of a system to map control system configurations for vehicle torque actuators according to an exemplary aspect;

FIG. 2 is a system diagram presenting features of the system of FIG. 1;

FIG. 3 is a system diagram presenting domain translation and fusion of control actions for the system of FIG. 1;

FIG. 4 is a system diagram presenting a control action translation into a torque bias ratio for the system of FIG. 1;

FIG. 5 is a system diagram presenting arbitration of constraints for traction control for the system of FIG. 1;

FIG. 6 is a system diagram presenting translation of control action into a torque bias ratio for the system of FIG. 1;

FIG. 7 is a flow diagram presenting lateral and yaw stability control determination for the system of FIG. 1;

FIG. 8 is a flow diagram presenting wheel stability control prioritizing wheel stability over lap time for the system of FIG. 1;

FIG. 9 is a flow diagram presenting translation of control action into a torque bias ratio and assignment of a minimum torque reference for the system of FIG. 1; and

FIG. 10 is a flow diagram presenting corner exit boost control prioritization of lateral capability versus lap time for the system of FIG. 1.

### DETAILED DESCRIPTION

The following description is merely exemplary in nature and is not intended to limit the present disclosure, application, or uses.

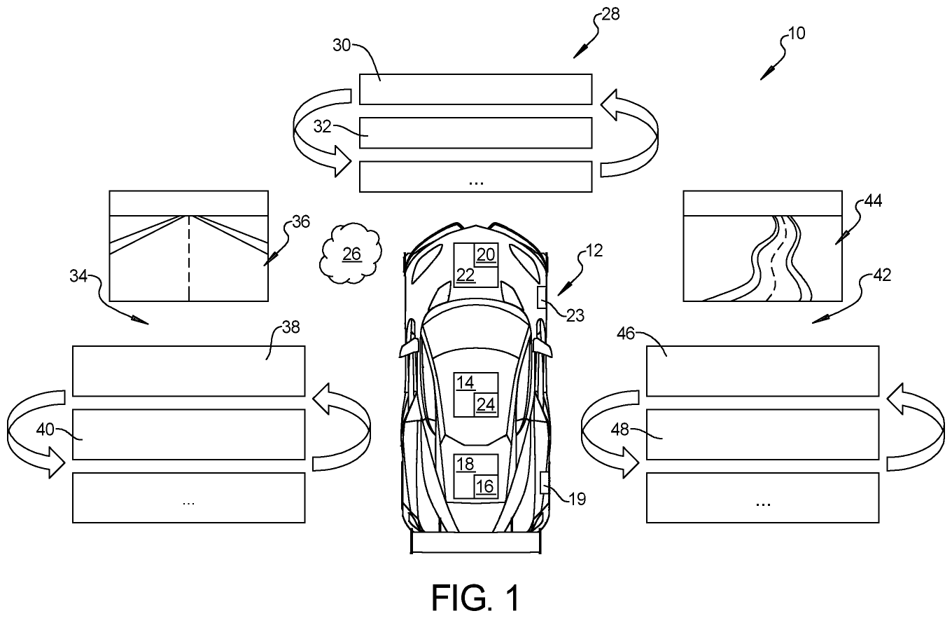

Referring to FIG. 1, a system to map control system configurations for vehicle torque actuators 10 is provided for controlling operating torque for a vehicle 12 using a controller 14 such as a central processing unit or a control module. The controller 14 may define a modular controller and a non-linear gain-scheduling controller. The controller 14 receives input from multiple sensors of the vehicle 12 which are described in greater detail herein and actuates and coordinates action of independent longitudinal torque actuators including a first torque actuator 16 of a first power unit 18 such as a combustion engine delivering torque to rear wheels 19 of the vehicle 12, and a second torque actuator 20 of a second power unit 22 such as an electric motor delivering torque to front wheels 23 of the vehicle 12. The controller 14 may include or be included with a computer 24 having independent memory and may also communicate remotely to a database provided for example in a cloud database 26.

The computer 24 described in reference to FIG. 1 is a non-generalized, electronic control device having a preprogrammed digital controller or processor, memory or non-transitory computer readable medium used to store data such as control logic, software applications, instructions, computer code, data, lookup tables, etc., and a transceiver or input/output ports. The computer readable medium includes any type of medium capable of being accessed by a computer, such as read only memory (ROM), random access memory (RAM), a hard disk drive, a compact disc (CD), a digital video disc (DVD), or any other type of memory. The non-transitory computer readable medium excludes wired, wireless, optical, or other communication links that transport transitory electrical or other signals. The non-transitory computer readable medium includes media where data can be permanently stored and media where data can be stored and later overwritten, such as a rewritable optical disc or an erasable memory device. Computer code includes any type of program code, including source code, object code, and executable code.

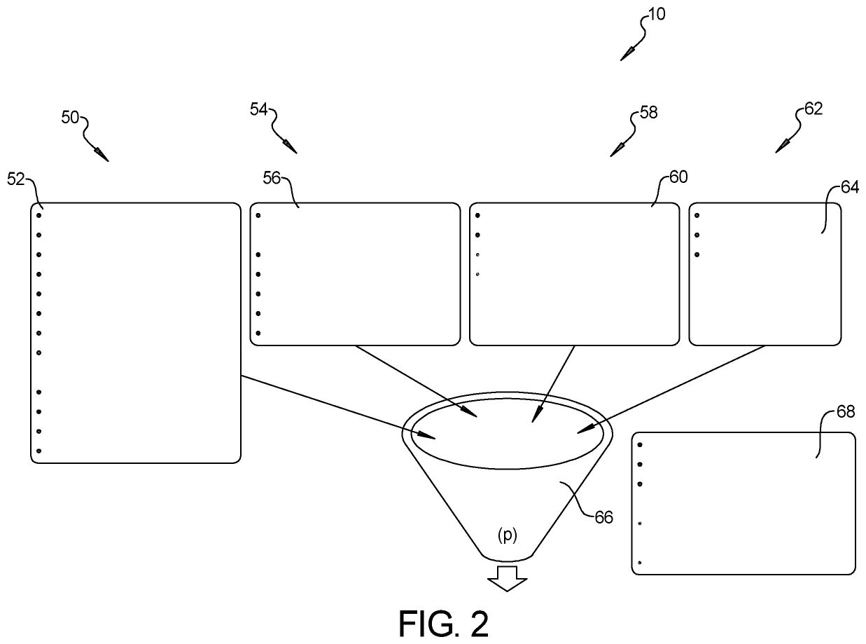

The controller 14 accesses multiple vehicle configurations, examples of which are provided in reference to FIG. 2, to establish a vehicle operating mode 28. The configurations may be prioritized, for example a first configuration 30 may be deemed to be a highest priority and is indicated as priority 1 and a second configuration 32 may be deemed of a next highest priority and is therefore indicated as priority 2.

The vehicle 12 may be operating in one of multiple modes. For example, in a first mode 34 the vehicle 12 is traveling on a straight roadway section 36. During this time changes to the torque configurations may be minimal, such as a lateral motion request 38 to change vehicle lane, or a meet driver request 40 such as to accelerate the vehicle 12. In an exemplary second mode 42 the vehicle 12 is traveling on a curving roadway section 4. Torque configurations may be more involved in this mode such as to meet a driver request 46 including to accelerate or decelerate the vehicle 12 during a curve, or to maintain side slip control 48 during the curve.

The system to map control system configurations for vehicle torque actuators 10 functions using multiple input items, including multiple configurations 50 discussed above in reference to FIG. 1. The configurations 50 may include but are not limited to: a desired torque; a traction value; propulsion limits; a slip target; a driver request; an eBoost signal from a front drive; a steering neutrality; a total torque reduction; a traction control system (TCS) integration; a rear traction limits overflow; and the like. According to several aspects, an eBoost signal may define a brake-by-wire system signal allowing the vehicle operator to adjust a brake pedal feel depending on a mode the operator selects. A brake pressure eBoost signal is forwarded to the computer 24. Applying the eBoost signal, a brake pressure is then transferred to all the vehicle brakes via an eBoost unit combining for example four components: a master cylinder, a vacuum booster, a vacuum pump and an electronic brake control module using traditional brake fluid.

The input items also include identification of one or more operating points 54. The operating points 54 may include but are not limited to: a drive mode such as tour or track; a traction control state including performance traction management (PTM) or electronic stability control (ESC); a surface friction (Mu); a highway driving point; and the like.

The input items also include identification of one or more configuration classifications 58. The configuration classifications 58 may include but are not limited to: a torque constraint; a torque reference; an enabling condition; and the like.

The input items also include identification of one or more priority assignments 62. The priority assignments 62 may include but are not limited to a priority 1; a priority 2 and the like. The priority assignments 62 are applied to the configurations 52, the operating points 54 and the configuration classifications 58 to speed up determination of a control action 66 as sensed conditions change.

With continuing reference to FIG. 2 and again to FIG. 1, the control action 66 is output to the first torque actuator 16 of the first power unit 18 and to the second torque actuator 20 of the second power unit 22. The control action 66 may include but is not limited to a lateral control; a slip control; a feedforward control; a rear/front traction control and the like.

Multiple vehicle sensors may be used in the system to map control system configurations for vehicle torque actuators 10. These may include but are not limited to: vehicle speed sensors, torque sensors, lateral accelerometers, steering sensors including steering angle sensors and steering velocity sensors, braking sensors, yaw rate sensors, surface friction sensors, wheel sensors and the like.

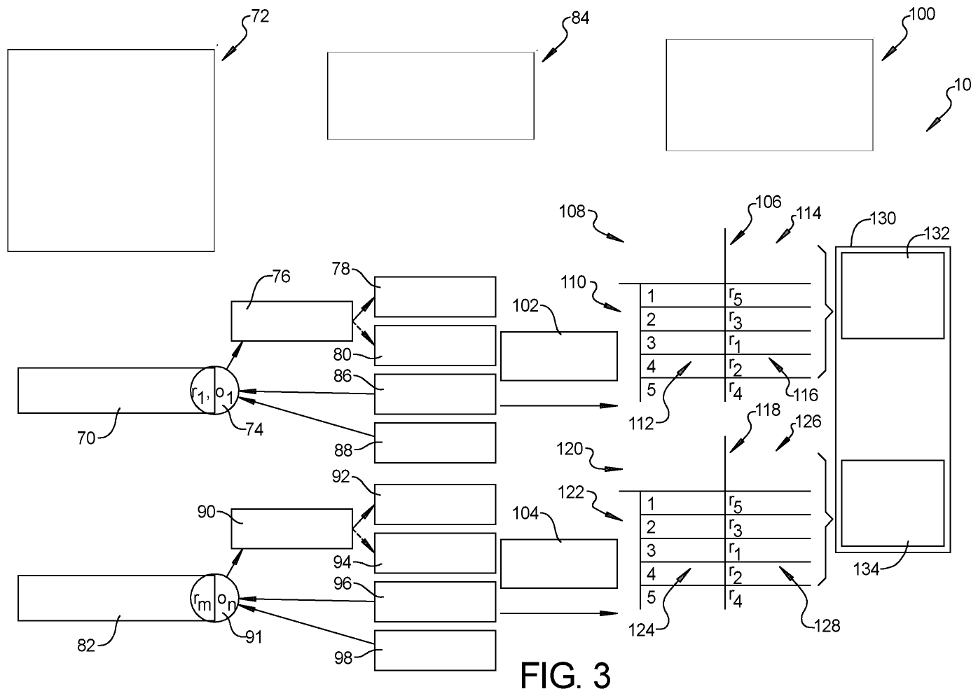

Referring to FIG. 3 and again to FIGS. 1 through 2, the system to map control system configurations for vehicle torque actuators 10 may be operated as follows. In a translation step 70, torque elements are translated to allow differing torque items to be evaluated and modified using a common database. The translation includes the following. In a mapping stage 72 given sets of configurations (Ri) and operating points (o₁) multiple pairs (Ri, o₁) 74 which are εR×0 have mapped to each (configuration, operating point) one of the following: an axle torque split ratio reference point; one or more axle torque split ratio constraints; and control system configurations such as a fuel economy. This generates a first torque translation 76. In the example shown in FIG. 3, a reference point 78 and a constraint 80 are added to the torque translation 76.

In a configurations prioritization step 82 a configurations prioritization is performed to identify a priority to be applied to individual ones of the torque translations. This includes mapping to each configuration and operating point pair from (Ri, o₁) to (rₘ, oₙ) the following items, including: 1) enabling conditions; and 2) a priority. For example, a set of enabling conditions 86 and at least one priority 88 are added to create a second torque translation 90 using multiple pairs (Rm, oₙ) 91 which are _{ϵ}R×0 have mapped to each (configuration, operating point) to include a reference point 92, a constraint 94, at least one enabling condition 96 and a least one priority 98.

In a fusion and control action step 100 a fusion is performed of the above configurations according to the torque translation and the assigned priority together and one or more control actions are identified. Initially, in a first collection step 102 all of the configurations Ri for the points o₁ are collected. Then, in a second collection step 104 all of the configurations Ri for the points oₙ are collected. The output of the first collection step 102 is input into a first chart 106. The first chart 106 includes an operating point 1 column 108 and a priority block 110 having exemplary priorities 112 ranging from 1 through 5 for operating point 1. A configuration column 114 identifies a configuration 116 for individual ones of the priorities 112. Similarly, the output of the second collection step 104 is input into a second chart 118. The second chart 118 includes an operating point n column 120 and a priority block 122 having exemplary priorities 124 ranging from 1 through 5 for operating point n. A configuration column 126 identifies a configuration 128 for individual ones of the priorities 124.

A fusion step 130 is then performed to fuse the configurations according to individual translations and their priority, which is followed by determination of a control action as discussed in reference to FIG. 2. For example, in a first determination 132 a control action is determined for operating point o₁ and in a second determination 134 a control action is determined for operating point oₙ.

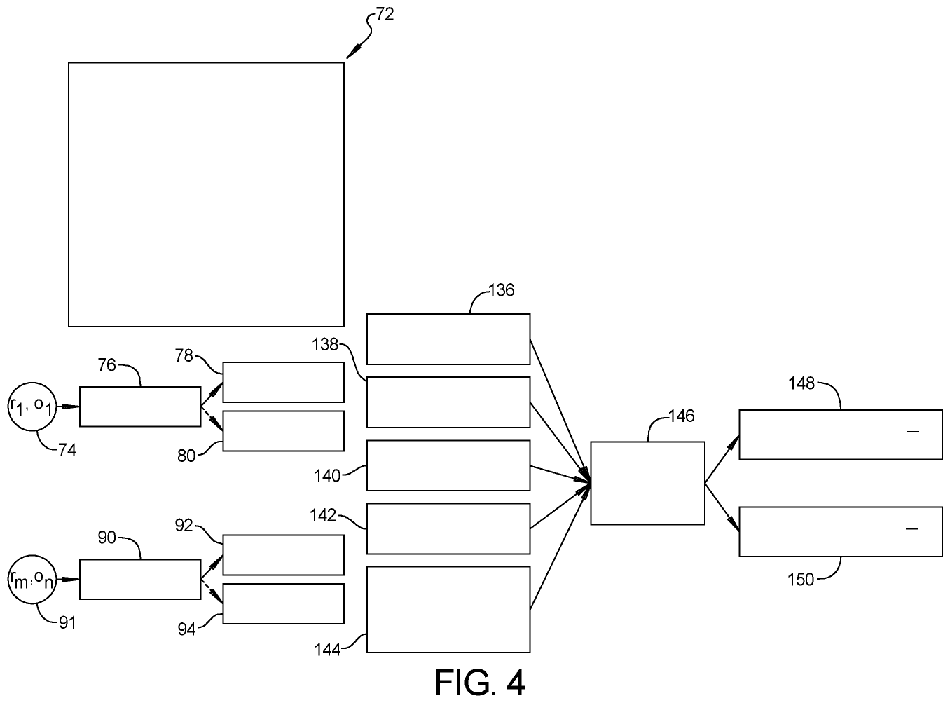

Referring to FIG. 4, a lateral stability motion control defines a control action translated into a torque bias ratio and assigned as a maximum of a minimum constraint. Lateral motion control achieves a configuration on steering neutrality, for example the vehicle 12 rotates precisely according to a driver's steering input, and lateral stability, wherein the vehicle does not spin out of control. Indicators of the vehicle's lateral state are translated to a normalized measure of lateral stability, which admits constraints on the axle torque split ratio. A configuration translation is performed. Operating points in this context can refer to any combination of vehicle dynamical state including speed and surface μ and chassis controls operating mode defining performance traction management.

A set of operating constraints include an understeering angle 136, a lateral acceleration a_{y} 138, a velocity vₓ and v_{y} 140, a yaw rate r 142, and a desired drive torque Tx^{des} and an estimated drive torque Tx 144. A normalized measure of lateral stability 146 is identified from the constraints. An axle torque split ratio upper limit 148 and an axle torque split ratio lower limit 150 are also determined from the normalized measure of lateral stability 146.

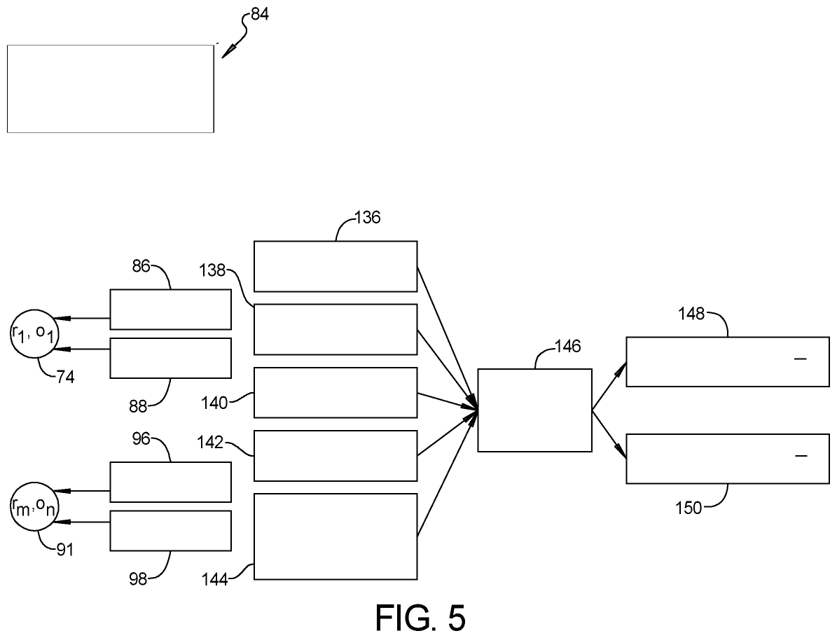

Referring to FIG. 5 and again to FIG. 4, the control action is translated into a torque bias ratio and assigned as a maximum or a minimum constraint. For configurations prioritization each configuration and operating point is mapped with one or more enabling conditions and a priority as described in reference to FIG. 3. Lateral motion control is enabled if all the following conditions are met: at least one wheel speed sensor is functional; at least one inertial measurement unit (IMU) is functional; and a steering sensor is functional. Lateral motion control is assigned the highest priority across all operating points.

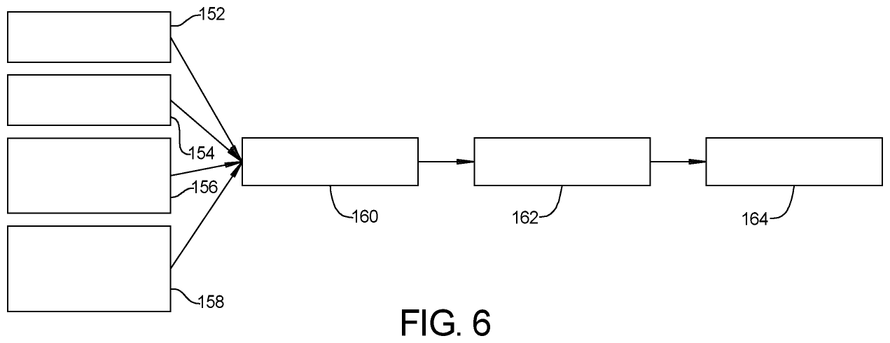

Referring to FIG. 6 and again to FIG. 3, for wheel stability control the control action is translated into a torque bias ratio and assigned as a reference point. The delta slip speed regulation control configuration translation is performed as follows. Operating points in this context can refer to any combination of vehicle dynamical state such as speed and surface and chassis controls operating mode including performance traction management. Delta slip speed regulation control achieves a configuration on vehicle balance given saturation of either axle. Delta slip speed regulation control measures of axle saturation are used to generate a reference or target delta slip speed, for example a slip speed of a rear axle less that of a front axle, which is then regulated using a nonlinear proportional integral derivative (PID) regulator.

A set of operating constraints include a lateral acceleration a_{y} 152, a velocity vₓ154, slip speeds of a front axle v_{x,f} and a rear axle v_{x,r} 156, and a desired drive torque Tx^{des} and an estimated drive torque Tx 158. The constraints are applied to determine a delta slip speed target Δₓ 160. The delta slip speed target Δₓ 160 is regulated using a nonlinear PID regulator 162 and an axle torque split ratio p_{dssr} 164 is generated.

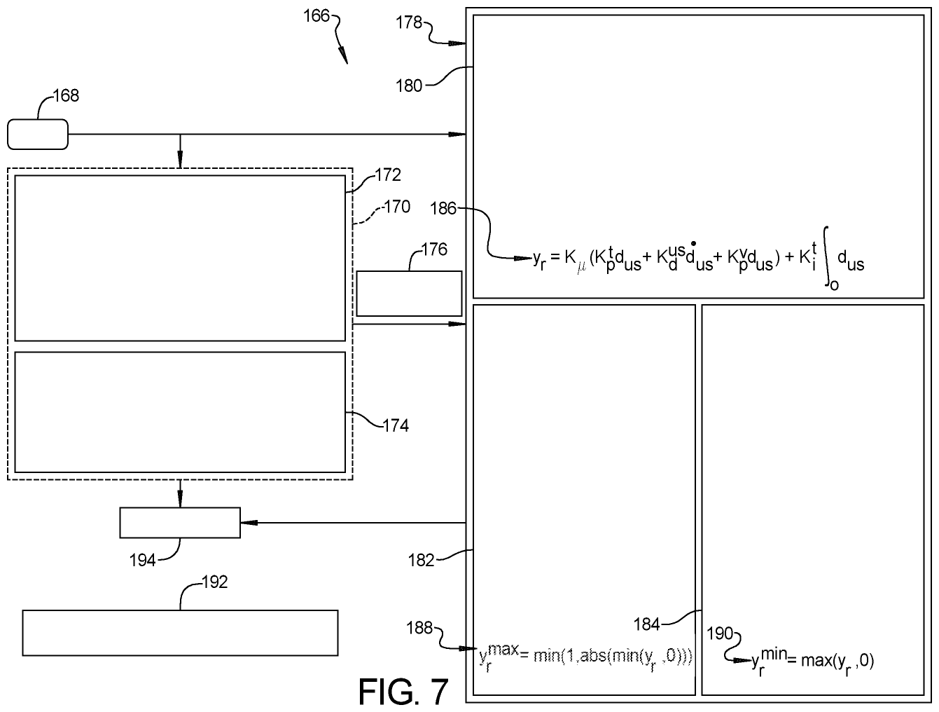

Referring to FIG. 7, a flow diagram 166 identifies an algorithm flowchart to resolve a priority of wheel stability over yaw stability. The flowchart begins at a start step 168, which is followed by a torque capacity determination 170. Based on a software mode and an effective lateral acceleration a_{y}, a reduce torque capacity determination 172 is made of a rear axle capacity. If the driver requests more torque than the rear axle capacity, the requested torque id limited to the rear axle capacity. Also occurring in the torque capacity determination 170, in a propulsion intervention step 174 limited torques are provided. Based on a propulsion intervention status, a maximum allowable torque on each axle is determined. Based on an output of the reduce torque capacity determination 172 and the propulsion intervention step 174 a torque capacity 176 is identified.

In parallel with the torque capacity determination 170, a yaw control determination 178 is conducted. The yaw control determination 178 includes a yaw control front/rear split offset determination 180, a yaw control maximum front/rear split limit determination 182 and a yaw control minimum front/rear split limit determination 184. During the yaw control front/rear split offset determination 180 based on a surface (μ) an understeering angle (δᵤₛ), a requested driver torque (τ), a vehicle speed (V), and an understeering velocity (\dot{δ}ᵤₛ), a normalized measure of the understeering behavior of the vehicle is determined, wherein-1 implies full understeer and +1 implies full oversteer. An equation 186 is applied to identify the normalized measure of the understeering behavior.

During the yaw control maximum front/rear split limit determination 182 negative values of front/rear split offset are used to populate a maximum limit, wherein the amount of torque that can be sent to the front if the vehicle is understeering is reduced. An equation 188 is applied to identify the yaw control maximum front/rear split limit.

During the yaw control minimum front/rear split limit determination 184 positive values of front/rear split offset are used to populate a minimum limit, wherein it is mandated that at least a certain amount of torque be sent to the front when the vehicle is oversteering. An equation 190 is applied to identify the yaw control minimum front/rear split limit.

Each of the torque capacity 176 generated by the torque capacity determination 170 and a group 192 having the maximum front/rear split limit and the minimum front/rear split limit are forwarded to an arbitration unit 194. The arbitration unit 194 prioritizes wheel stability control and yaw stability control.

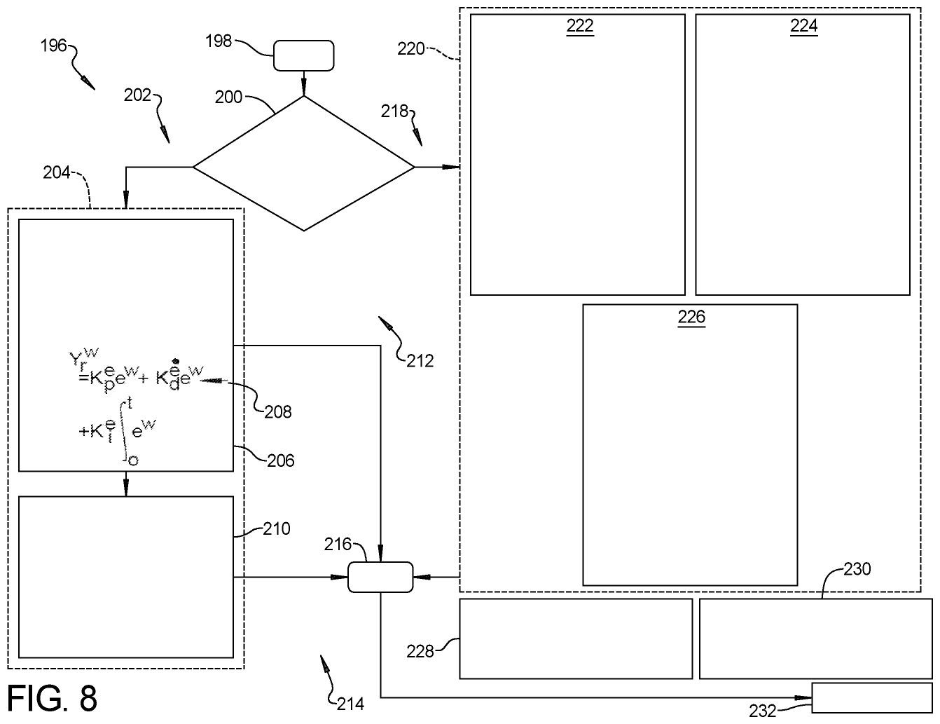

Referring to FIG. 8, a wheel stability control flowchart 196 resolves the priority of wheel stability over lap time with boost. Following a start step 198 in a decision step 200 a determination is made if the vehicle 12 is experiencing sudden or excessive slip. If a response to the decision step 200 is YES 202, a torque analysis 204 conducted. In a first torque determination 206 a front/rear torque split is identified including application of a PID control to achieve target wheel slip speeds. An algorithm 208 is applied to perform the first torque determination 206. Following the first torque determination 206 a tractive limits squeeze 210 is conducted wherein upper tractive limits for the front and rear are set equal to a front/rear torque split target. A front desired torque and a rear desired torque 212 from the torque analysis 204 and front and rear upper limits 214 output from the tractive limits squeeze 210 are collectively forwarded to a merge device 216.

If a response to the decision step 200 is NO 218, a tractive limit determination 220 is conducted. During the tractive limit determination 220 a second torque determination 222 is identified wherein a front/rear torque split from a feedforward control is bound by lateral control limits. A front upper tractive limit determination 224 is then conducted which considers a TCS boost, a hybrid boost, a minimum lateral control limit, a feedforward longitudinal tire capacity, and an estimated front wheel torque. A rear upper tractive limit determination 226 is then conducted which considers a TCS boost, a hybrid boost, a maximum lateral control limit, a feedforward longitudinal tire capacity, and an estimated rear wheel torque. An output of the tractive limit determination 220 is also forwarded to the merge device 216 wherein a first set 228 of front and rear upper limits, a front desired torque and a rear desired torque are merged with a second set 230 of a front desired torque, a rear desired torque and front and rear upper limits. A merged output of the data entered into the merge device 216 is forwarded to an arbitration device 232.

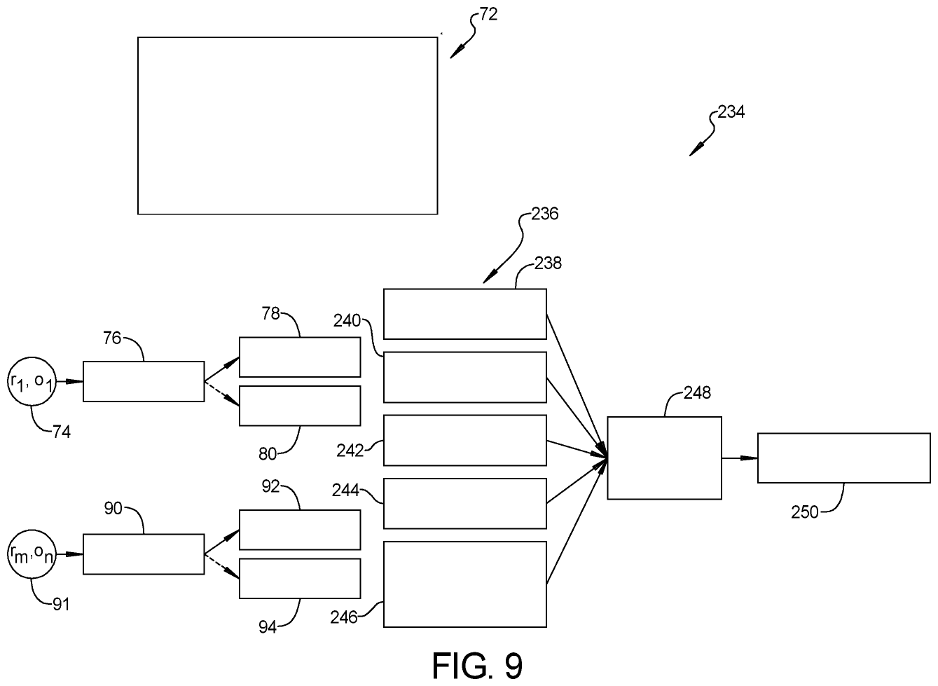

Referring to FIG. 9, a corner exit boost control configuration translation flow diagram 234 identifies a control action translated into a torque bias ratio and assigned as a minimum torque reference, including for example a boost control. Initially, and with continuing reference to FIG. 3, given sets of configurations (Ri) and operating points (o₁) 236 multiple pairs (Ri, o₁) 74 which are _{ϵ}R×0 have mapped to each (configuration, operating point) one of the following: an axle torque split ratio reference point; one or more axle torque split ratio constraints; and control system configurations such as a fuel economy. This generates the first torque translation 76 having a reference point 78 and a constraint 80 added to the torque translation 76. The second torque translation 90 using multiple pairs (Rm, oₙ) 91 which are _{ϵ}R×0 have mapped to each (configuration, operating point) include the reference point 92, the constraint 94 added to the second torque translation 90.

The operating points 236 in this context can refer to any to any combination of vehicle dynamical state including a vehicle speed and a surface μ. Delta slip speed regulation control achieves a configuration on vehicle balance given saturation of either axle.

The corner exit boost 248 achieves a configuration related to vehicle peak acceleration and lap time, for example the vehicle provides the driver with a maximum acceleration while maintaining a vehicle path tracking capability. Inputs such as lateral acceleration, velocity, and the like are considered to find the optimum balance between acceleration and maneuverability.

The operating points 236 may include a steering angle 238, a lateral acceleration 240, a_{y}, a velocity, vₓ, v_{y} 242, a battery state-of-charge (SOC) 244 and a detection of track driving 246. The operating points 236 are analyzed to identify a corner exit boost 248. The corner exit boost 248 is applied to identify an axle torque split ratio reference 250.

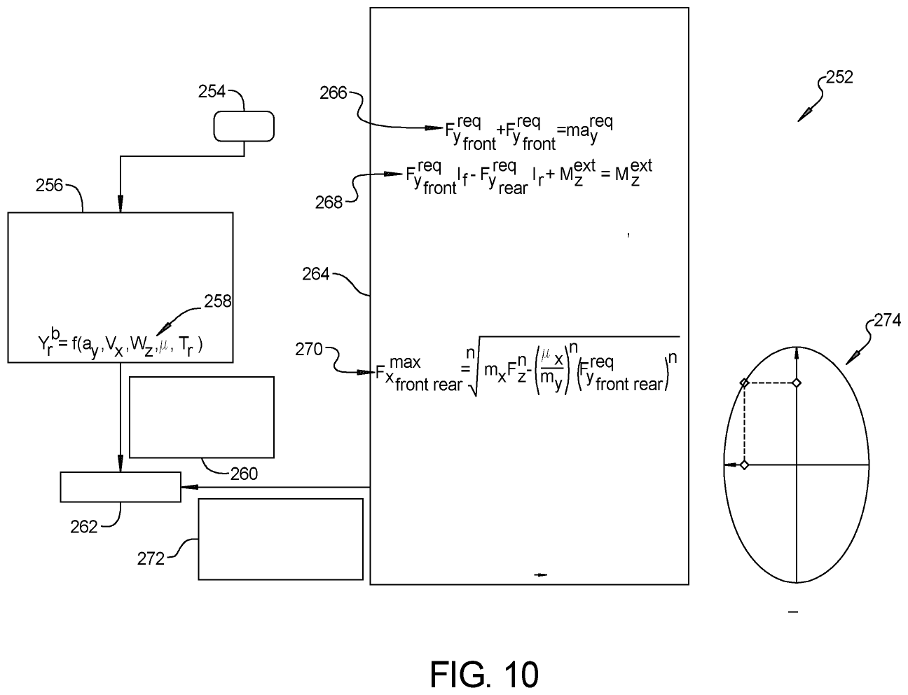

Referring to FIG. 10, a corner exist boost control flow diagram 252 identifies algorithms that may be applied to identify a priority of lateral capability vs lap time (boost). From a start step 254 a determination 256 is made of a corner exit boost which is bound using vehicle dynamics. The corner exit boost may be calculated using equation 258. A result of equation 258 is provided with a combination 260 including a front/rear torque split and a requested boost to an arbitration stage 262.

In parallel with the determination 256 a computation 264 is performed to compute initial tractive limits. Equations 266 and 268 are solved to identify front and rear tractive limit requests. Applying the front and rear tractive limit requests, a tire ellipse equation 270 is used to solve for maximum and minimum tractive limits. By applying a graph 274 it may be shown that if Fₓ≤Fₓ^{max} sufficient lateral capacity is available to meet a requested lateral force, wherein F_{y}≥F_{y}^{req}.

The torque split target limit is defined as a non-negativity for propulsion and total hybrid boost torque. The torque vectoring feedforward target includes an arbitration of rear axle torque, an enable/disable torque vectoring long target, and an enable/disable yaw moment transient target. The tractive limit includes a tire torque capacity for lateral and wheel control. The lateral control includes propulsion intervention limits, a total torque reduction, a front motor low-capacity indicator, a rear limit activation, a driver axle torque request traction limit calculation and a minimum limit. The torque vectoring yaw target includes an adjustment to yaw error target and different rates when increasing/decreasing yaw error target. The wheel control uses: an arbitration between TCS and wheel control; an adjustment to the slip target; a flare activation; a front axle capacity achieved; a rear axle slip limit, a minimum tractive limit set for a traction control system; and a rear overflow to front.

According to several aspects, the method of the present disclosure provides a scalable control strategy with a systematic tuning capability and a modular design to actuate and coordinate independent longitudinal torque actuators. The modular architecture intelligently and systematically handles conflicting configurations depending upon given conditions and control priority. A method is provided to simulate mechanical coupling between vehicle driven axles to mimic a desired feeling of mechanical all-wheel drive systems.

The present integration methodology and modularity of the controller 14 and the computer 24 allows easier remediation over independent control subsystems. A modular controller 14 with a straightforward systematic tuning capability is structured. The modularity of the controller 14 and its systematic capability for tuning are utilized as a holistic control architecture for different electric vehicles with an overarching goal of axle coupling. Electronically controlled longitudinal torque actuators are used. The nonlinear gain-scheduling controller 14 is applied for wheel control to address variation of closed loop dynamics at different slip targets. The modular control methodology improves integration of chassis and ADAS control components to provide a fused holistic controller, which handles configurations of both chassis and ADAS control-related features.

The following may be performed by the system to map control system configurations for vehicle torque actuators 10. The present system distributes torque that enhances a lateral capability of an all-wheel drive (AWD) vehicle. This helps the AWD vehicle driver to achieve superior performance over vehicle controllability. Individual components are tuned in a systematic way to ensure a highest outcome for control performance. This strategy ensures vehicle handling stability.

A system to map control system configurations for vehicle torque actuators 10 of the present disclosure offers several advantages. These include provision of a scalable control strategy having a systematic tuning capability and a modular design to actuate and coordinate independent longitudinal torque actuators. The architecture of the system to map control system configurations for vehicle torque actuators 10 intelligently and systematically handles conflicting configurations depending upon given conditions and control priorities. The present system simulates mechanical coupling between vehicle driven axles to mimic a desired feeling of mechanical all-wheel drive systems.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system to map control system configurations for vehicle torque actuators, comprising:
a control unit of a vehicle;
a first torque actuator of a first power unit delivering torque to rear wheels of the vehicle, and a second torque actuator of a second power unit delivering torque to front wheels of the vehicle;
multiple input items received by the control unit, including:
multiple configurations;
one or more operating points;
multiple configuration classifications including: a torque constraint; a torque reference; and an enabling condition; and
identification of one or more priority assignments;
the priority assignments being applied to the configurations, the operating points and the configuration classifications to determine a control action as sensed vehicle operating conditions change; and
individual ones of the configurations being mapped to a normalized torque split ratio.

2. The system to map control system configurations for vehicle torque actuators of claim 1, further including the configurations being categorized as reference points or constraints.

3. The system to map control system configurations for vehicle torque actuators of claim 2, wherein the constraints further include a set of operating constraints including an understeering angle, a lateral acceleration, a velocity, a yaw rate, a desired drive torque and an estimated drive torque.

4. The system to map control system configurations for vehicle torque actuators of claim 3, wherein:
a normalized measure of lateral stability is identified from the constraints; and
an axle torque split ratio upper limit and an axle torque split ratio lower limit are also determined from the normalized measure of lateral stability.

5. The system to map control system configurations for vehicle torque actuators of claim 2, including a priority-based arbitration as a function of the vehicle operating mode, the control unit accessing individual ones of the multiple configurations to establish a vehicle operating mode.

6. The system to map control system configurations for vehicle torque actuators of claim 1, wherein the configurations are prioritized, including a first configuration deemed to be a highest priority and indicated as priority 1 and a second configuration deemed of a next highest priority and indicated as priority 2.

7. The system to map control system configurations for vehicle torque actuators of claim 1, wherein the multiple configurations include at least one of: a desired torque; a traction value; propulsion limits; a slip target; a driver request; an eBoost signal from a second power unit; a steering neutrality; a total torque reduction; a traction control system (TCS) integration; and a rear traction limits overflow.

8. The system to map control system configurations for vehicle torque actuators of claim 1, wherein the operating points include at least one of: a drive mode including tour or track; a traction control state including performance traction management (PTM) or electronic stability control (ESC); a surface friction (Mu); and a highway driving point.

9. The system to map control system configurations for vehicle torque actuators of claim 1, wherein:
the first power unit defines a combustion engine; and
the second power unit defines an electric motor.

10. The system to map control system configurations for vehicle torque actuators of claim 1, wherein the multiple input items include identification of one or more operating points, including: a drive mode including tour or track; a traction control state including performance traction management (PTM) or electronic stability control (ESC); a surface friction (Mu); and a highway driving point.

11. A method to map control system configurations for vehicle torque actuators, comprising:
translating torque elements to allow differing torque items to be evaluated and modified using a common database;
performing a configurations prioritization from a group of configurations to identify a priority assigned to individual ones of the torque elements;
fusing the configurations prioritization according to the torque elements and the priority assigned together;
determining multiple control actions;
generating a target delta slip speed as measures of vehicle axle saturation; and
regulating the target delta slip speed using a nonlinear proportional integral derivative (PID) regulator.

12. The method of claim 11, further including the translating torque elements includes in a mapping stage given sets of the group of configurations (Ri) and a set of operating points (o₁) multiple pairs (Ri, o₁) mapping to individual configurations of the group of configurations and individual ones of the operating points one of:
an axle torque split ratio reference point of an axle torque split ratio;
one or more axle torque split ratio constraints of the axle torque split ratio; and
control system configurations such as a fuel economy.

13. The method of claim 12, further including:
translating at least a first one of the multiple control actions as a lateral stability motion control into a torque bias ratio and assigning a maximum of a minimum constraint; and
translating at least a second one of the multiple control actions as a wheel stability control into the torque bias ratio and assigning a reference point.

14. The method of claim 13, further including mapping to individual ones of the multiple pairs from (Ri, o₁) to (rₘ, oₙ) the following items, including: 1) enabling conditions; and 2) the priority.

15. The method of claim 14, further including:
collecting all of the group of configurations Ri for the set of operating points (o₁) in a first collection step;
collecting all of the group of configurations Ri for the set of operating points oₙ in a second collection step;
inputting an output of the first collection step into a first chart, the first chart including an operating point 1 column and a priority block having priorities ranging from 1 through 5 for an operating point 1;
identifying a configuration for individual ones of the priorities for the operating point 1 using the first chart;
inputting an output of the second collection step into a second chart, the second chart including an operating point n column and a priority block having priorities ranging from 1 through 5 for the operating point n; and
identifying a configuration for individual ones of the priorities for the operating point n using the second chart.

16. The method of claim 12, further including translating indicators of a vehicle lateral state to a normalized measure of lateral stability, which admits the constraints on the axle torque split ratio.

17. The method of claim 16, further including translating a control action for wheel stability control into a torque bias ratio and assigning as a reference point.

18. A method to map control system configurations to a domain for vehicle torque actuators, comprising:
delivering torque to rear wheels of a vehicle using a first torque actuator of a first power unit, and delivering torque to front wheels of the vehicle using a second torque actuator of a second power unit;
translating elements of the torque into a domain to allow differing ones of the elements of the torque to be evaluated and modified using a common database;
coordinating a feedback-based delta slip-speed regulation control and a lateral motion control;
coordinating a hybrid boost control and an external traction control system; and
performing non-linear gain scheduling of a controller to regulate dynamics of a wheel slip.

19. The method of claim 18, further including performing a configurations prioritization using a group of configurations to identify a priority to be assigned to individual ones of the elements of the torque.

20. The method of claim 19, further including mapping individual ones of the group of configurations to a normalized torque split ratio.
